(19) United States
(12) Patent Application Publication
(10) Pub. No.: US 2014/0285395 A1
(43) Pub. Date: Sep. 25, 2014

(54) MECHANICALLY RESISTANT LOOP ANTENNA FOR A PASSPORT

(71) Applicant: Gemalto SA, Meudon (FR)

(72) Inventors: Blandine Alleysson, Aubagne (FR); Arek Buyukkalender, Marseille (FR); Christophe Bousquet, La Seyne Sur Mer (FR)

(21) Appl. No.: 14/349,204

(22) PCT Filed: Oct. 2, 2012
(86) PCT No.: PCT/EP2012/069409

§ 371 Date: Apr. 2, 2014

(30) Foreign Application Priority Data
Oct. 3, 2011 (EP) 11306276.4

(51) Int. Cl. H01Q 7/00

(52) U.S. Cl. CPC H01Q 7/00
USPC 343/866

(57) ABSTRACT

The invention relates to an antenna for a radio frequency transponder comprising a flat base with a longitudinal edge, an antenna for receiving via electromagnetic coupling on the base, said edge being intended to be parallel to a binding of the booklet, said antenna comprising parallel and perpendicular coils that extend respectively parallel and perpendicular to the longitudinal edge; the transponder is characterized in that said parallel coils have close-together inter-coil spacing at least in an area of binding of the booklet with respect to the inter-coil spacing of the perpendicular coils. The invention also relates to a portable electronic object including said transponder.

### FIELD OF THE INVENTION

The invention relates to a magnetic field antenna for a radio frequency transponder.

It relates in particular to the field of radio frequency antenna bases such as electronic passports, travel documents, smart cards, tickets, radio frequency labels, radio frequency transponders, inserts (or inlays).

More particularly, such objects may be compliant with the ISO/IEC 14443 standard.

### PRIOR ART

Changing the arrangement of the coils of a radio frequency antenna and more particularly the inter-coil spacing to meet the frequency tuning required for the communication is known. Areas may be in particular provided in the antenna where the coils are intentionally spaced with respect to a normal inter-coils distance so as to have an inter-coil capacity to adjust on frequency tuning.

Locally reducing the inter-coil spacing of the antennas to create an insulating bridge at a location where the coils are spaced close-together and enabling the crossing over of a wire or obtaining a microcircuit astride the coils is known.

### TECHNICAL PROBLEM

In passports, and more particularly the antenna bases consisting of a sheet of the passport booklet or the cover thereof, the inventors have found brittle points during the following strength test comprising bending and twisting (WG3TF4_NO232_ test specifications for MPRs V3.2 §5.7).

The problem identified by the inventors is that the natural tendency to fold P of a cover extends to the layers containing the antenna and may thus cause the breaking thereof by shearing.

The aim of the invention is to provide a transponder antenna that is more resistant to the above-mentioned bending stress.

The tendency to fold has been located at a midline located substantially perpendicular to the binding of the passport booklet.

The inventors' studies have shown that the closer together the wires of the antenna, the more resistant the antenna to bending and damage.

However, given the radio frequency RFID properties expected from the antenna, the spacing between the coils is not free.

### SUMMARY OF THE INVENTION

The invention consists in bringing closer together the wires at least only in the identified stress area so as not to change the radio frequencies performances of the antenna while increasing the bending/twisting strength thereof.

The invention therefore relates to an antenna comprising a flat base with a longitudinal edge, an antenna for receiving via electromagnetic coupling on the base, said edge being intended to be parallel to a binding of the booklet, said antenna comprising parallel and perpendicular coils that extend respectively parallel and perpendicular to the longitudinal edge;

the antenna is characterized in that said parallel coils have close-together inter-coil spacing with respect to the inter-coil spacing of the perpendicular coils, said parallel coils being located at least on a midline of the base, said midline being perpendicular to the longitudinal edge.

According to other characteristics of the antenna,

The edge is adjacent to a binding of the booklet;

The parallel coils have an inter-coil spacing (ES) ranging from 0.1 to 0.5 mm.

The invention also relates to a portable electronic object including the magnetic field antenna above. It may preferably form a passport, a booklet, the antenna being carried by a sheet or a cover of the booklet or passport.

### BRIEF DESCRIPTION OF THE FIGURES

FIG. 1 shows a bending test applied to a passport booklet;

FIG. 2 is a side view of the passport showing the binding and the opposite edge;

FIG. 3 shows a fold appearing on a transversal right bisector of the passport;

FIG. 4 illustrates a transponder of the prior art comprising an antenna and an integrated circuit module positioned on a passport page or cover;

FIGS. 5, 6, 7, 8 respectively illustrate a first, second, third and fourth embodiment of the invention;

FIG. 9 shows an alternative embodiment of FIG. 5

FIG. 10 shows the inter-coil spacing of an antenna as imposed by the required RF performances;

FIG. 11 shows the reduced inter-coil spacing of an antenna in the region submitted to bending stress.

### DESCRIPTION

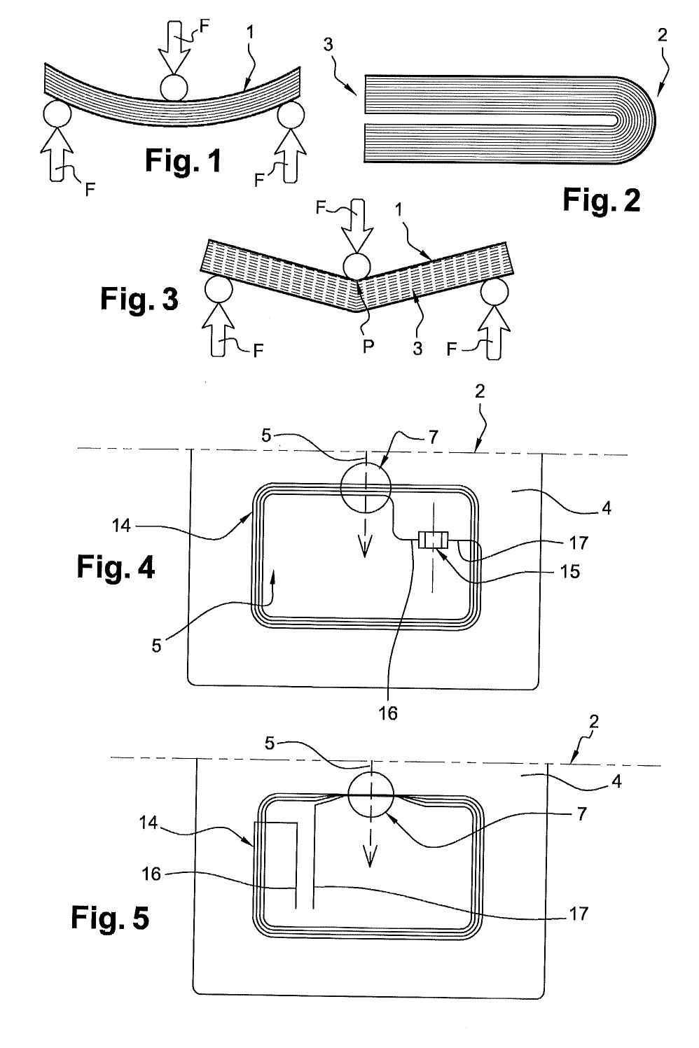

In FIG. 1, a booklet 1, more particularly of a passport, is submitted to a bending test, as shown in the Figure, with a pressure F exerted at the center and at the edges, in reaction.

FIG. 2 is a side view of the passport showing the binding 2 and the opposite edge 3.

In FIG. 3, the test bending gives rise to a fold P on the transversal right bisector of the booklet because it has a relatively rigid binding 2.

When bending is applied perpendicularly to the binding 2, the latter starts to mark a fold P and the stress builds up on the fold. The fold starts to expand and causes the shearing of the antenna coils in the area 7 in the first place. Then the shearing spreads over the entire width of the booklet to the coils of the antenna located close to the booklet edge opposite the binding.

In FIG. 4, a sheet of the prior art passport has a plane base 4 carrying a radio frequency transponder, a longitudinal edge 2 close to the passport binding, an antenna 14 for receiving via electromagnetic coupling on the base. The antenna comprises coils surrounding a central coupling surface. The coils extend at least partially parallel to and near the longitudinal edge 2.

Here, the antenna is made of a wire inlaid in the base. The antenna is connected to an electronic micromodule comprising a radio frequency integrated circuit chip 15 via the connecting ends 16 and 17. Other techniques for producing antennas known to the persons skilled in the art may be provided, such as embroidery, transfer of an already wire-wound antenna, or etching. However, for matters of communication performance, the invention preferably aims at wire antennas having substantially constant sections (or diameters). However, the invention may provide for the narrowing of the coils width in the area 7, in addition to a reduced inter-coil spacing. In the absolute, only the antenna may be taken into consideration by the coils but also by the substrate thereof, as regards the holding of the coils together. It may include at least the coils themselves and the substrate. According to the invention, antenna also means an antenna or radio frequency transponder insert (or inlay) with or without a connected integrated circuit chip. The antenna can be finished or semi-finished insofar as it can be provided to be connected or not to one or more electrical components.

If appropriate in some applications, more particularly for a dual interface object or a passive antenna radio frequency object, the antenna may be plain (not connected to an integrated circuit chip). The antenna may be connected to a capacitor.

The coils of the antenna or at least those positioned along the edge 2 adjacent to the binding, have a substantially constant inter-coil spacing.

The spacing is for example commonly ranging from 0.5 to 2 mm for wires having diameters ranging from 50 to 150 μm.

A region 7 of the coils located near the longitudinal edge 2 is a region particularly exposed to a stress axis as symbolized by an arrow 5.

In FIG. 5, according to a first embodiment of the invention, an antenna base 4 has an antenna 14 laid on or parallel to one of the major surfaces thereof. The antenna base is substantially consistent with the previous Figure except for a difference as described below.

As the base here is a sheet of a passport, the edge 2 is designed to be parallel to a binding of a passport booklet. It can be seen that the rectangle-shaped antenna 14 has parallel coils (longer sides of the rectangle) and perpendicular (shorter sides of the rectangle) extending respectively parallel and perpendicular to the longitudinal edge 2.

According to a characteristic of this first embodiment, at least a portion of the coils positioned in a region 7 near the edge 2 adjacent to the binding, has a close-together inter-coil spacing ES with respect to the normal spacing EL of the coils of the other regions. In other words, the parallel coils have, at least in one place or region 7, a close-together inter-coil spacing ES with respect to the inter-coil spacing EL of the perpendicular coils (See FIG. 10-11).

The surface portion 7 is preferably located on a transversal midline 5 of the base 4, which extends perpendicularly to the longitudinal edge 2.

The edge 2 is designed to be adjacent to a hinge or binding of the booklet.

The close-together coils preferably have an inter-coil spacing ES ranging from 0.1 to 0.5 mm. As for the coils, which are not close to each other, the inter-coil spacing EL ranges from 0.5 to 2 mm.

The wires have diameters ranging from 50 to 150 μm.

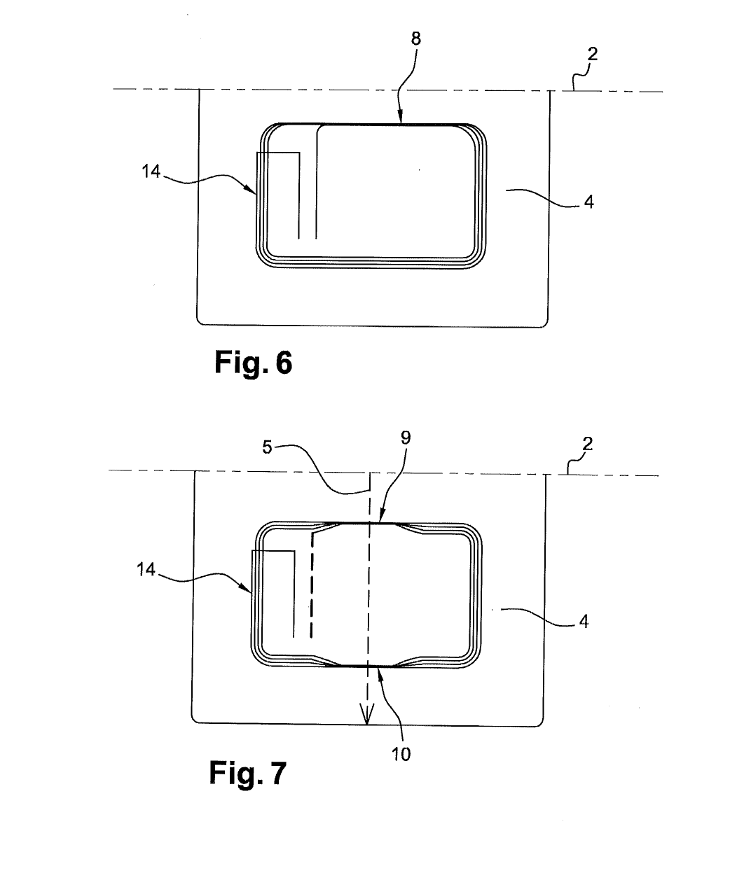

In FIG. 6, according to a second embodiment, substantially the entire edge of the antenna adjacent to the binding or to the edge 2 is formed with a reduced inter-coil spacing especially with respect to the coil portions arranged perpendicularly to the edge 2.

In FIG. 7, the antenna comprises two portions 9 and 10 running on from the stress axis 5. The portion is located on the coils opposite those near the fold.

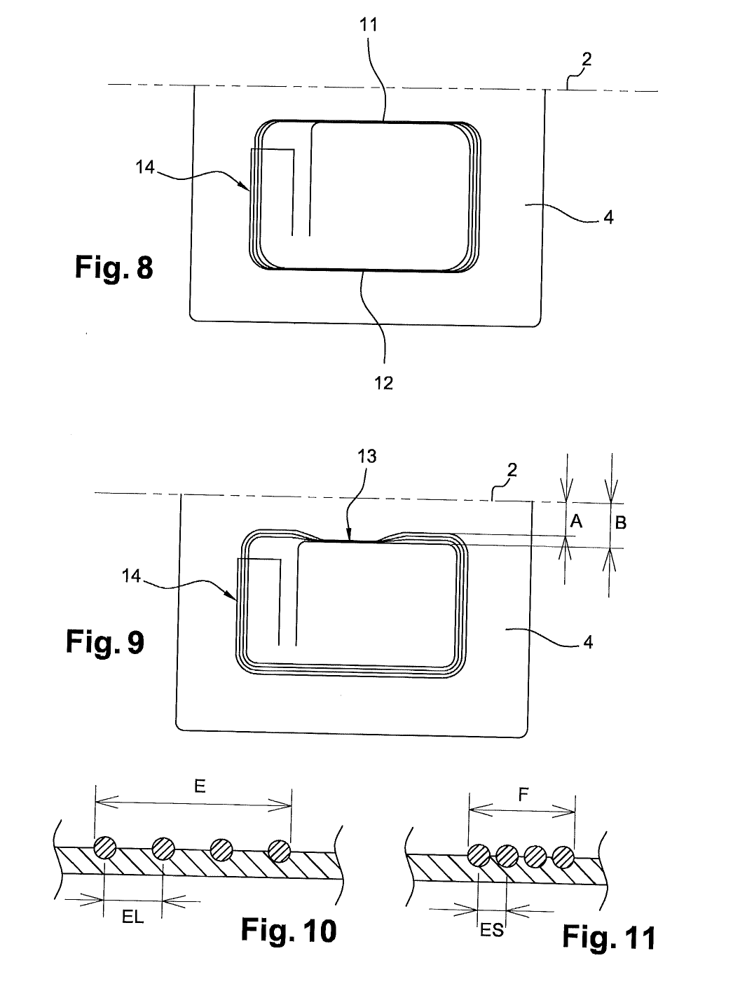

In FIG. 8, according to a third embodiment, both sides 11, 12 of the antenna extending parallel to the edge adjacent to the fold 2 are made with a reduced inter-coil spacing ES with respect to the coils oriented transversely to the edge 2.

In FIG. 9, according to a fourth embodiment, the coils of the region 7 not only have a reduced spacing ES but they are all shifted toward the inner coil of the antenna 14 so that the outer coil of the antenna in the region 7 is located further from the edge 2 than the outer coil of the remaining portions of the antenna, parallel and adjacent to the edge 2.

In other words, the coils in the region 7 are close-together to the inner coil of the antenna.

It can be seen that the outer coil of the region 7 is at a distance B from the edge 2 which is greater than a distance A from the edge 2 to the outer coil portions parallel to the edge 2, outside the region 7.

In FIG. 10, the inter-coils spacing EL of an antenna in the regions not submitted to bending stress (e.g. in the portions of the antenna oriented perpendicular to the binding or the edge 2) is referred to as normal.

In FIG. 11, the inter-coils spacing ES of an antenna in the region submitted to bending mechanical stress is referred to as reduced.

For example, the values EL are ranging from 0.5 to 2 mm.

For example, the values ES are ranging from 0.1 to 0.5 mm. ES is preferably ranging from 0.1 to 0.4 mm. The number of coils is indicative only, in the example ranging from 3 to 7.

The invention may relate to any portable electronic object with the transponder described above. In particular, it may include a passport, a booklet, with the transponder being carried by a sheet or a cover of the booklet.

1. A magnetic field antenna for a radio frequency transponder, said antenna comprising a flat base with a longitudinal edge, an antenna on the base for receiving signals via electromagnetic coupling, said edge being intended to be parallel to a binding of the booklet, said antenna comprising parallel and perpendicular coils that extend respectively parallel and perpendicular to the longitudinal edge,
wherein said parallel coils have an inter-coil spacing that is closer than the inter-coil spacing of the perpendicular coils, said parallel coils being located at least in a region substantially located on a midline of the base, said midline being perpendicular to the longitudinal edge.

2. A magnetic field antenna according to claim 1, wherein said edge is adjacent to a binding of a booklet.

3. A magnetic field antenna according to claim 1, wherein the perpendicular coils have an inter-coil spacing ranging from 0.5 to 2 mm.

4. A magnetic field antenna according to claim 1, wherein the parallel coils have an inter-coil spacing ranging from 0.1 to 0.5 mm.

5. A magnetic field antenna according to claim 1, wherein the antenna wire has a diameter ranging from 50 to 150 μm.

6. A magnetic field antenna according to claim 1, wherein the antenna comprises an inlaid wire.

7. A magnetic field antenna according to claim 1, wherein the outermost parallel coil of said region is located at a distance B from the longitudinal edge which is greater than a distance A for the outermost parallel outer coil portions located outside the region.

8. A portable electronic object including the magnetic field antenna according to claim 1.

9. A portable electronic object according to claim 8 composing a passport, a booklet, with the antenna being carried by a sheet or a booklet or passport cover.
